(19) United States
(12) Patent Application Publication
(10) Pub. No.: US 2005/0278866 A1
(43) Pub. Date: Dec. 22, 2005

(54) Multi-function tool for surfers

(76) Inventor: Isaac Madarieta, Carlsbad, CA (US)

Correspondence Address: Karl M. Steins;Steins & Associates, Suite 120, 2333 Camino del Rio South, San Diego, CA, 92108, US

(21) Appl. No.: 10/870,291

(22) Filed: Jun. 17, 2004

(51) Int. Cl. B26B 11/00

(52) U.S. Cl. 7/120; 7/165

(57) ABSTRACT

A Multi-function Tool for Surfers is disclosed. The device incorporates a plurality of tools associated with it that are of specific utility in the surfing industry. There is a wax comb built in to the handle/casing. There is a leash hook to assist in threading a new tether into a surfboard. There is also one or more screwdriver/allen wrenches for repairs and maintenance.

### BACKGROUND OF THE INVENTION

1. Field of the Invention

This invention relates generally to Sporting Goods and, more specifically, to a Multi-function Tool for Surfers.

2. Description of Related Art

Multi-function tools are available in a wide variety of configurations and designed for a wide variety of specific applications. These tools can be general purpose devices for use in place of a toolbox full of tools, or they might also be designed to serve one particular purpose. An example of a general purpose multi-function tool is known as the Leatherman™ Multi-Function Tool. This tool is essentially a folding device that includes a pliers, screwdriver, knife and a variety of other tools. It's an extremely durable tool that has substantial utility in a generic sense. It is not, however, configured to be used in any particular application and, therefore, does not have specialized tools associated with it.

An example of a specialized multi-function tool is found in U.S. Pat. No. 5,787,535 to Epstein. This tool is for cleaning and maintenance of a chainsaw. It has a plurality of Foldable Tool Instruments 11 that can be folded within a Rectangular Casing 13. The tool instrument set includes a brush, a saw, two or more files, a screwdriver and a pick. Certainly the inventor of that device expected that having these particular instruments would be valuable for the application of chainsaw maintenance. There are other examples like the Epstein Device, but here to date, nothing has been provided for use with the surfing industry. What is needed, then, is a multi-function tool for the care and maintenance of surfboards and related accessories.

### SUMMARY OF THE INVENTION

In light of the aforementioned problems associated with the prior devices, it is an object of the present invention to provide a Multi-function Tool for Surfers. The device should have a plurality of tools associated with it that are of specific utility in the surfing industry. In particular, there should be a wax comb built in to the handle/casing. There should be a leash hook to assist in threading a new tether into a surfboard. There should also be one or more screwdriver/allen wrenches for repairs and maintenance.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is U.S. Pat. No. 5,787,535 to Epstein;

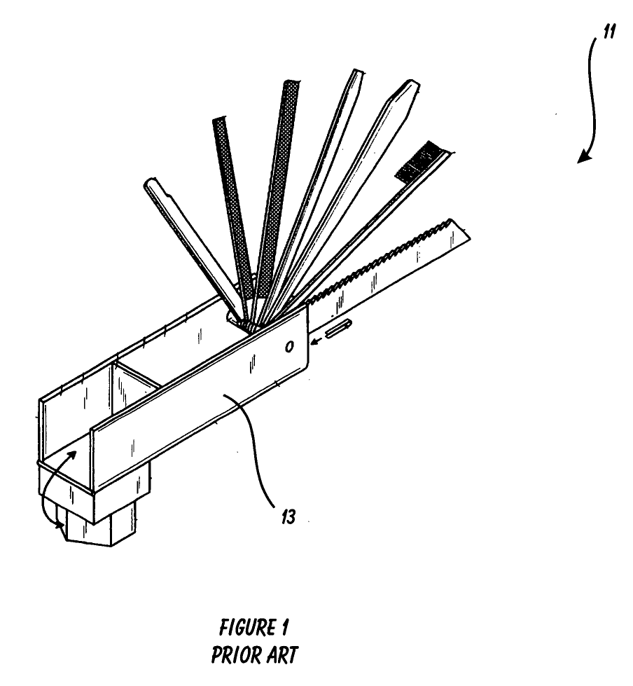

FIG. 2 is a perspective view of a preferred embodiment of the Surfer's Tool of the present invention;

FIG. 3 is another perspective view of the Tool of FIG. 2; and

FIG. 4 is an exploded perspective view of the Tool of FIGS. 2 and 3.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Multi-function Tool for Surfers.

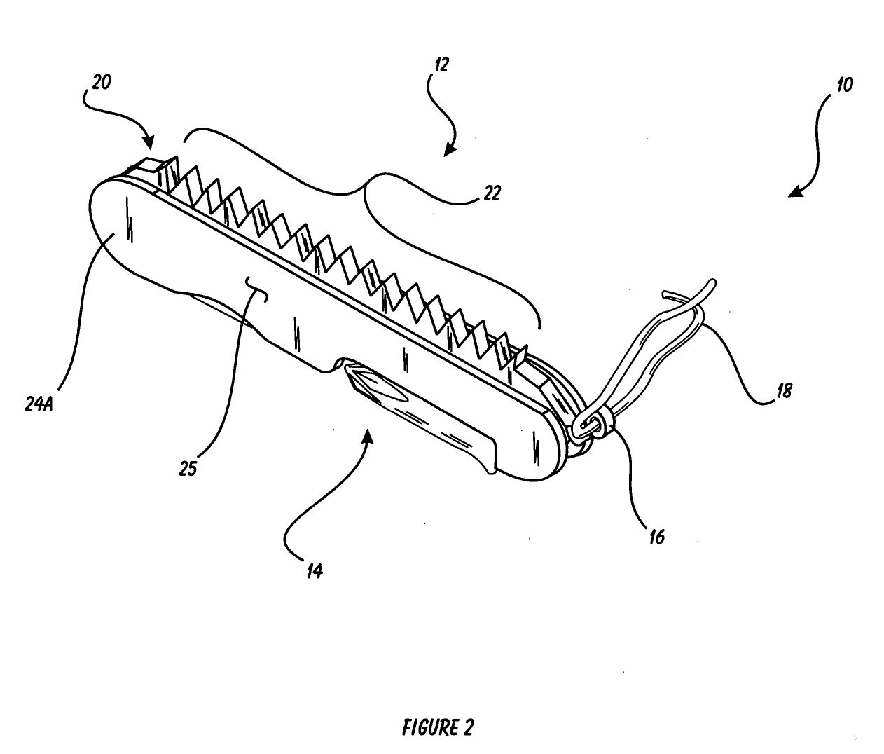

The present invention can best be understood by initial consideration of FIG. 2. FIG. 2 is a perspective view of a preferred embodiment of the Surfer's Tool 10 of the present invention. The Tool 10 defines a Top Side 12 and a Bottom Side 14, simply labeled as such to provide clarity as we discuss the attributes of this Tool 10. At one or more of the ends of the Tool 10 extends a Ring 16 through which a Tether 18 may be looped. The Tether 18 is preferably constructed from material similar to or the same as the attachment string or tether that interconnects a surfboard and the surfboard leash. As such, this material is easily obtainable and, furthermore, could be used as replacement material for a broken attachment string on a surfboard. The Top Side 12 of the Tool 10 preferably has a Scraper Instrument 20 extending upwardly from it. The Scraper Instrument 20 is essentially a component of the Tool 10 that has a plurality of Pointed Teeth 22 extending upwardly from it. The Scraper Instrument 20 is used to roughen wax and other surface coatings on a surfboard (i.e. to make a new wax coating on a surfboard less slippery). In this perspective view, a First Side Cover 24A is also shown. Side Cover 24A may have a Display Portion 25 dispersed thereon whereby indicia or other designs might be displayed.

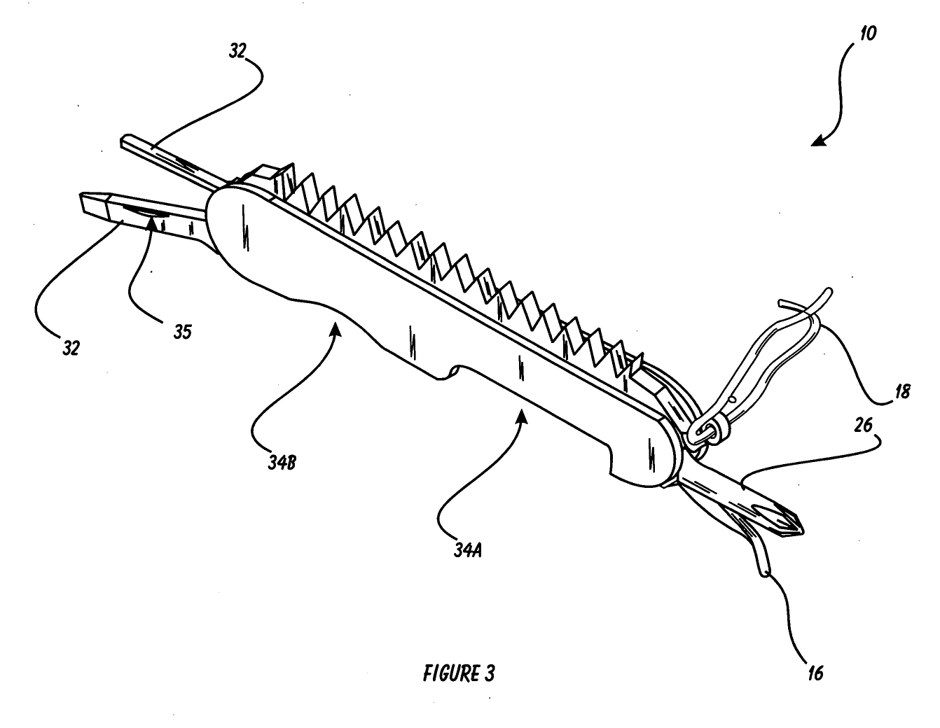

Now turning to FIG. 3, we can begin to discuss the various instruments included with the Tool 10. FIG. 3 is another perspective view of the Tool of FIG. 2. In this FIG. 3, the instruments included within the Tool 10 are all fully or partially extended from their storage locations. In this version of the invention, in addition to the Scraper Instrument 20, there is a Phillips Screwdriver Instrument 26, a Leash Hook Instrument 28, an Allen Wrench Instrument 30, and a Bladed Screwdriver Instrument 32. The Phillips Screwdriver 26, Allen Wrench 30 and Blade Screwdriver 32 Instruments are all fairly self-explanatory and are designed to be used on different bolts and nuts associated with a surfboard. A Leash Hook Instrument 28 is provided to assist the user in reattaching-a leash to a surfboard such as after the leash has broken, et cetera.

On the First Side Cover 24A, there are formed a pair of Notches 34A and 34B. As show here, Notch 34A is somewhat larger than Notch 34B. This is so that Notch 34A can accommodate the thicker, longer Phillips Screwdriver Instrument 26, whereas the Notch 34B needs only grant access to the Fingernail Ridge 35 formed in the Blade Screwdriver Instrument 32.

The Scraper Instrument 20 is preferably made from a non-metallic material that is extremely durable, such as a hard plastic or other material. This will provide adequate scraping capability without risk of damaging the surfboard. The other instruments 26 through 32 will preferably be constructed from a non-corrosive yet durable material that can be used in a saltwater environment for prolonged periods without risk of deterioration due to corrosion.

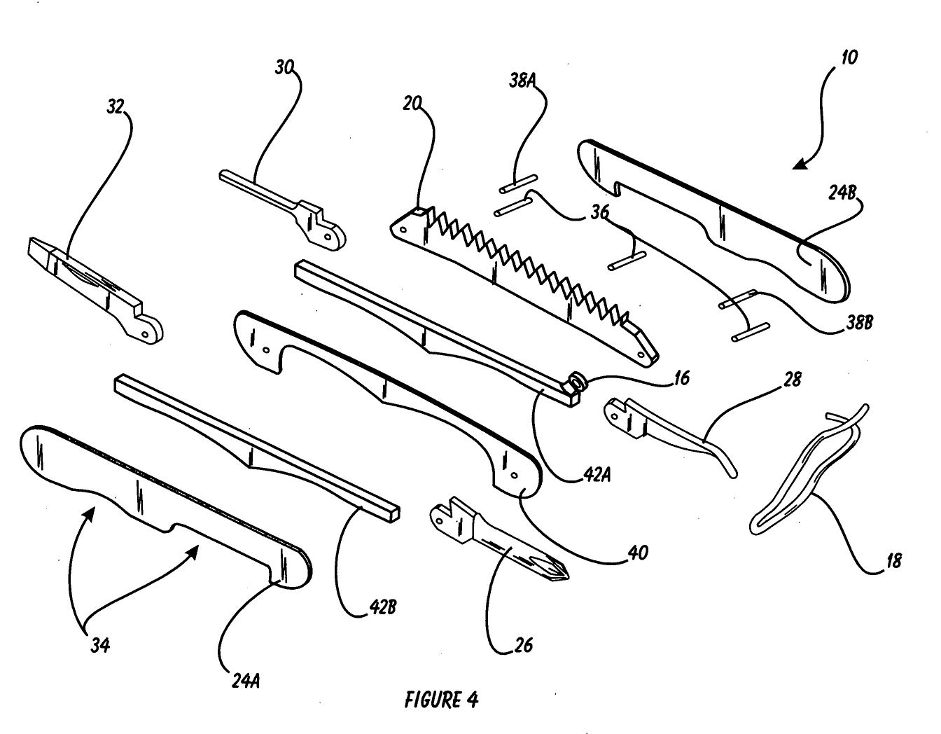

Now turning to FIG. 4, we can more closely examine the assembly of the present invention. FIG. 4 is an exploded perspective view of the Tool of FIGS. 2 and 3. The Tool 10 is essentially a sandwich of several unique elements. All of the parts are held between a First Side Cover 24A and a Second Side Cover 24B. These Covers 24 are attached to one another by a plurality of Assembly Pegs 36 that are preferably interference-fitted into apertures formed in each Cover 24. There will typically also be a first Axle Peg 38A and a Second Axle Peg 38B that provide an access of rotation for the folding instruments while additionally interconnects the two Side Covers 24.

The Scraper Instrument 20 is held between the two Side Covers 24 near the Top Side 12 of the Tool 10 such that the teeth are exposed for use. Also sandwiched between the Covers 24 are a First Spacer Member 42A and Second Spacer Member 42B. These members are disposed immediately beneath the Scraper Instrument 20, on either side of the Tool 10 adjacent to Covers 24. Centered within the Tool 10 is a Biasing Member 40. Biasing Member 40 provides a biasing force against the sides of the instruments in order to lock them either in place in a stowed position or in an extended position. In other words, the Biasing Member 40 prevents the instruments from rotating freely without some additional force asserted upon them by the user.

As shown, each of the Folding Instruments 26 through 32 is provided with an aperture or borer formed within it through which one of the Axle Pegs 38 passes as the Axle Peg 38 interconnects the two Side Covers 24.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

1. A multi-function tool, comprising:
a housing defined by a top side and a bottom side; and
a scraping instrument disposed on said top side.

2. The tool of claim 1, wherein said-scraping tool defines a plurality of teeth extending upwardly from said top side.

3. The tool of claim 2, further defined by:
an axle peg attached to said housing; and
a first tool instrument engaging said axle peg to define an axis of rotation of said first tool instrument around said axle peg.

4. The tool of claim 3, wherein said first tool instrument comprises:
an attachment portion defining a substantially flat cross-section and an aperture formed therethrough to accept said axle peg; and
a leash hook extending from said attachment portion.

5. The tool of claim 4, further defined by a second tool instrument engaging said axle peg to define an axis of rotation of said second tool instrument around said axle peg.

6. The tool of claim 5, wherein said second tool instrument comprises:
an attachment portion defining a substantially flat cross-section and a aperture formed therethrough to accept said axle peg; and
a screwdriver extending from said attachment portion.

7. The tool of claim 6, further comprising:
a second axle peg attached to said housing; and
a third tool instrument engaging said axle peg to define an axis of rotation of said third tool instrument around said second axle peg.

8. The tool of claim 7, further comprising:
a second axle peg attached to said housing; and
a fourth tool instrument engaging said axle peg to define an axis of rotation of said fourth tool instrument around said second axle peg.

9. The tool of claim 8, wherein said housing comprises:
a first side cover; and
a second side cover, said side covers interconnected by said axle pegs and being arranged in generally parallel spaced relation.

10. The tool of claim 9, wherein said housing further comprises a plurality of assembly pegs interconnecting said side covers.

11. The tool of claim 10, wherein each said side cover is defined by a pair of notches formed therein to provide access to said tool instruments.

12. A folding tool, comprising:
a housing defined by a first side cover and a second side cover in generally parallel spaced relation and interconnected by at least two pegs;
at least one tool instrument attached to one said peg; and
a scraper instrument fixedly attached to said housing.

13. The tool of claim 12, wherein said at least one tool comprises a leash hook instrument.

14. The tool of claim 13, wherein said leash instrument comprises a generally flat attachment portion attached to said peg and a leash hook portion extending from said attachment portion.

15. The tool of claim 14, wherein said scraper instrument comprises a plurality of outwardly-facing teeth.

16. The tool of claim 15, further comprising an allen wrench tool, a blade screwdriver tool and a phillips screwdriver tool extendable from said housing.

17. The tool of claim 16, further comprising a ring extending from said housing.

18. The tool of claim 17, further comprising a tether threaded through said ring.

19. A multi-function surfer's tool, comprising:
a housing comprising a pair of side covers in spaced relation;
one or more spacing members between said side covers;
a biasing member between said side covers; and
a scraper element between said side covers, said scraper element defined by a plurality of outwardly-facing teeth formed thereon.

20. The tool of claim 19, further comprising a leash hook instrument between said side covers.
